(19) United States
(12) Patent Application Publication
(10) Pub. No.: US 2017/0177087 A1
(43) Pub. Date: Jun. 22, 2017

(54) HAND SKELETON COMPARISON AND SELECTION FOR HAND AND GESTURE RECOGNITION WITH A COMPUTING INTERFACE

(71) Applicant: INTEL CORPORATION, SANTA CLARA, CA (US)

(72) Inventors: ALON LERNER, Holon (IL); ITAMAR GLAZER, Jerusalem (IL); SHAHAR FLEISHMAN, Hod Hasharon (IL)

(73) Assignee: INTEL CORPORATION, SANTA CLARA, CA (US)

(21) Appl. No.: 14/975,549

(22) Filed: Dec. 18, 2015

(51) Int. Cl. G06F 3/01; G06K 9/00; G06F 3/00

(52) U.S. Cl. CPC G06F 3/017; G06F 3/005; G06K 9/00375

(57) ABSTRACT

Hand skeletons are compared to a hand image and selected. The hand skeletons are used for hand and gesture recognition with a computing interface. In one example, the method includes projecting points of a generated hand skeleton onto a received hand image, classifying the skeleton points as inside or outside the hand image, quantifying the comparison to generate a comparison quantity using a comparison function distance measurement, the comparison function distance measurement comprising an outside skeleton distance that includes a sum of distances from each outside skeleton point to a nearest inside skeleton point, applying the comparison function quantity to select the generated hand skeleton as a best match, and applying the selected hand skeleton to generate a command to a computer system command interface.

### FIELD

The present description relates to selecting a generated hand skeleton for hand and gesture recognition for a computing interface

### BACKGROUND

Many computer input and control systems are being developed which respond to hand motions and gestures. Rather than typing, pressing buttons, or operating a cursor control device, the user makes hand motions in front of a camera. Simpler systems respond only to hand waves and arm motions. For more detailed control, the movements of individual fingers are tracked.

In some systems, a depth-based hand tracking system is used. Different camera systems obtain the depth information in different ways. One such camera system uses two or more cameras physically spaced apart and compares simultaneous images to determine a distance from the cameras to the hand. Other camera systems use a rangefinder or proximity sensor either for particular points in the image or for the whole image such as a time-of-flight camera. A camera system with multiple sensors determines, not only the appearance of the hand, but also the distance to different points on the hand. The output of a hand tracking system is a full hand skeleton. The system tracks not only the movements of finger tips, but also the individual finger joints and wrist, the angles between the bones and the global position of the hand in space. Some systems track hand movements in three dimensions by fitting a model of the hand to an input video of the hand from the system camera.

Using the depth and the image information, a hand is tracked by iteratively generating a set of hand skeletons in different postures or poses. The skeletons are compared to the input depth image and the hand tracking system selects the skeleton that best matches the input depth image. The generated hand skeletons are defined by different hand postures. The postures are determined by the position of the hand in three dimensions, including distance, and the angles between the bones. The postures are also determined by a 3D model which accounts for the size, for example the lengths of the fingers and the size of the palm, and for the 3D shape of the hand.

The skeleton is first rendered using a graphics processor or another high speed parallel processing unit. The rendering is in three dimensions and can then be compared to the input image. The comparison process is a simple side by side comparison of two images. The graphics system then generates another skeleton and performs another comparison. The skeletons are all variations of some base skeleton so that the variations can be generated more quickly.

Once the hand motion is determined, then the motion can be interpreted as an input, such as a command, to the computing system. The hand tracking system delivers a command to an input system which then executes the command. Hand tracking can also be used for authentication and other purposes.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a diagram of an input depth image of a hand, a 2D projection of a hand skeleton and an overlay of the two according to an embodiment.

FIG. 2 is a diagram of a comparison operation with a hand skeleton and an input hand depth image according to an embodiment.

FIG. 3 is a diagram of a hand image and two hand skeletons to show a distance function according to an embodiment.

FIG. 4 is a process flow diagram of comparing and selecting a hand skeleton according to an embodiment.

FIG. 5 is a block diagram of a system for gesture recognition according to an embodiment.

FIG. 6 is an isometric diagram of a computing system for gesture recognition according to an embodiment.

FIG. 7 is an isometric diagram of an alternative computing system for gesture recognition according to an embodiment.

FIG. 8 is a block diagram of a computing device incorporating IR camera enhancements according to an embodiment.

### DETAILED DESCRIPTION

A hand tracking system for a depth camera system may be configured to use depth images obtained from a depth sensor to track a hand by iteratively generating a set of hand skeletons in different postures, comparing them to the input depth image and choosing the one which best matches it. The different hand skeletons are each defined by the posture that each skeleton represents and by its 3D shape representation, respectively.

The skeleton rendering and image comparisons are well-suited to graphics processing systems, however, not every system has sufficient graphics resources to perform the additional operations. The hand tracking operations may also stall a GPU (graphics processing unit) as the system waits for the GPU to finish a hand tracking operation. This can impact other urgent rendering tasks.

The described approach is well suited to being performed as a CPU (central processing unit) function for comparing any hand skeleton to a depth image obtained from a depth sensor. No rendered image is required which avoids many operations for rendering and sampling. At the same time, the comparisons are refined to provide a more meaningful value. Furthermore, if a set of skeletons is generated as variations of a base skeleton, the similarities can be exploited in order to increase the overall efficiency of comparing the entire set of skeletons. This reduced number of operations is more easily performed in a CPU.

A hand tracking system extracts a set of features and classifies them as potential fingers. The hand tracking system iteratively generates sets of skeletons in postures defined by the classified fingers. Based on a comparison function, the system chooses the skeleton most similar to the input image. In some embodiments, this selection is then iteratively refined by comparing the hand to additional similar skeletons.

As described herein, one or more skeletons in different postures are received as an input and compared to a depth image from a depth camera. The depth image has some of the pixels marked as locations corresponding to those in a skeleton. A two way comparison evaluates how well the skeleton hand matches the input hand and vice versa. It is determined in the two-way comparison whether a skeleton fits part of the input hand even if the skeleton does not cover all of the input hand. In the other direction it is determined whether the input hand fits the skeleton even though the input hand might not completely cover the skeleton.

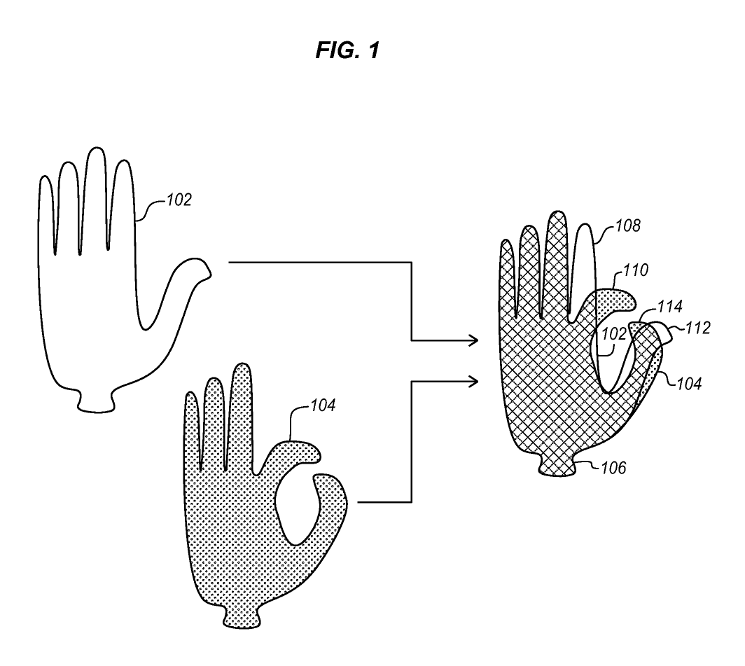

FIG. 1 is a diagram of an input depth image 102 of a hand from a camera, a 2D projection 104 of a hand skeleton, and an overlay of the image over the projection. The overlaps 106 cover most of the input hand image. However, the forefinger 108 and thumb 112 of the input image do not align with the forefinger 110 and thumb 114 of the generated skeleton. The overlapping region 106 does not adequately cover the input and skeleton hands.

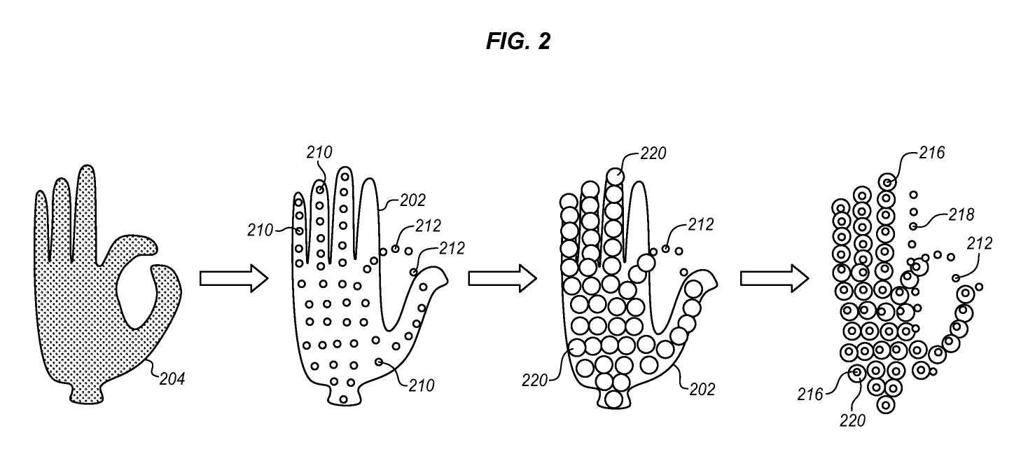

FIG. 2 is a diagram of a comparison operation with a skeleton 204 and an input hand image 202. A comparison function may be used to first sparsely sample points 210 on the skeleton and to then project the sampled points 210 onto the input hand image 202. The sampled points may then be classified as falling inside 210 or outside 212 of the input hand. Points 210 falling inside are dilated to form dilated points 220. In other words, the inside points are enlarged to cover a larger region. In some embodiments, the inside points are enlarged so that the edge of each enlarged point touches at least one other enlarged point. This is shown in FIG. 2 in which the points all contact another point.

Points on the input hand image are then sampled and classified. One set of input hand points 216 are covered by the dilated points 220, so that they are inside the dilated skeleton points. Another set of input hand points 218 are not covered by the dilated points 220 so that they are outside the skeleton points. As shown in FIG. 2, there are, accordingly, four sets of points: Skelᵢₙ 210, 220, Skelₒᵤₜ, 212, Handᵢₙ 216, and Handₒᵤₜ 218.

The inside points 210, 216 represent the overlap region for the generated skeleton and the input hand image. For the inside points (pᵢₙ) a direct distance computation, such as a number of pixels in the input hand image or any other distance unit, may be used. Therefore, each point pᵢₙ which is an element of the set of points in Handᵢₙ is un-projected back to 3D space and the distance to the closest point q on the skeleton surface model is computed. The distance values are summed over all pᵢₙ to get:

overlap=Σₚᵢₙdist(pᵢₙ,q) (Eq. 1)

The Skelᵢₙ points are, from a comparison viewpoint, equivalent to the Handᵢₙ points. Therefore no distance value computations are required. This simple distance summation may be understood in part using a ray analysis. Inside points 210, 216, i.e. points in the overlapping regions, are points that are in both the hand and skeleton. Any ray from the camera through the hand point or the skeleton point hits both the input hand and the skeleton.

Therefore, for the inside points the described 3D distance can be used. This distance corresponds to the distances between points taken from the hand image and un-projected into 3D space and their closest point on the surface of the hand skeleton.

For the outside points 212, 218, there are two types. Each skeleton outside point pₛ₋ₒᵤₜ is an element of the set of points 212 in Skelₒᵤₜ. In the example of FIG. 2, these points belong to a finger. A search is conducted for the shortest path, moving from sample point to sample point along the finger to find a skeleton point qₛ₋ᵢₙ which is an element of the set of points in Skelᵢₙ. The path is projected onto the image and the distance, for example the number of pixels, is computed. For points pₛ₋ₒᵤₜ which belong to the palm, a similar search is conducted for the closest inside skeleton point qₛ₋ᵢₙ. The points pₛ₋ₒᵤₜ and qₛ₋ᵢₙ are similarly projected onto the hand image and the pixel distance between them is computed. The square of the values is summed over all pₛ₋ₒᵤₜ to get the outside skeleton distances, out_skel:

out_skel=Σₚₛ₋ₒᵤₜdist²(Pₛ₋ₒᵤₜ,qₛ₋ᵢₙ) (Eq. 2)

Points 218 which belong to Handₒᵤₜ as shown in FIG. 2 do not have a finger or palm classification. However, a distance value equivalent to the one computed for the Skelₒᵤₜ points 212 may be computed. A distance transform is determined or computed for all the points 218 which belong to the hand mask but are not part of the overlap region 220. This distance is equivalent to the pixel distance along the shortest path from each point to any point in the overlap region. The square of these values may be summed over all pₕ₋ₒᵤₜ to get the outside hand distances, out_hand:

out_hand=Σₚₕ₋ₒᵤₜdist²(pₕ₋ₒᵤₜ) (Eq. 3)

The values of the overlap distances, the outer hand distances and the outer skeleton distances may be combined to provide a final value for a comparison function, f(skel,hand). This is shown in Equation 4. As shown in Equation 4, there are weights w in the sum which may be varied in any of a variety of ways to emphasize various distances. For example, if the hand tracking system was used to determine finger gestures, then differences in the fingers would be weighted more heavily than overlap in the palm. In both out_skel and out_hand computations instead of computing the sum of squared distances, different exponential functions can be used in order to increase the importance of distant points.

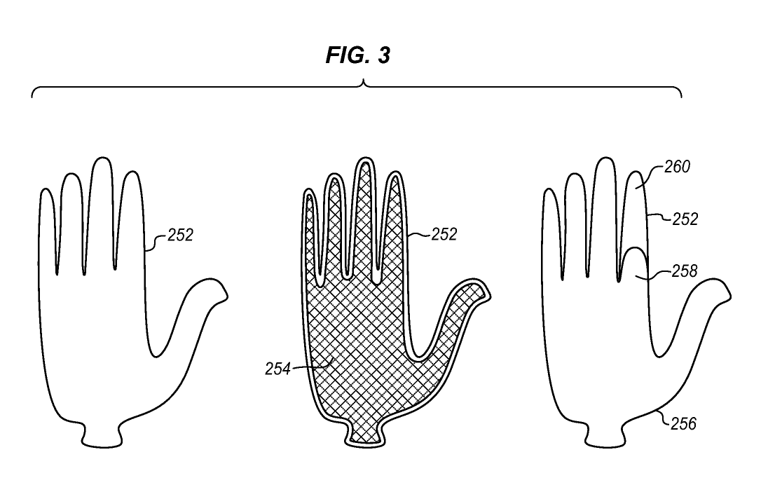

For outside points 212, 218, i.e. points outside the overlapping region, a ray shot from the camera would not hit both hands. Therefore a more complex distance function is used. FIG. 3 shows a hand image and two skeletons to illustrate the basis for the distance function. A given actual hand image 252 is shown on the left. Two different skeletons 254, 256 are shown as possible matches to this hand image. The middle hand 254 is smaller in size while the hand on the right 256 is the correct size but its index finger is not placed correctly. The index finger 258 of the skeleton is folded down, while the index finger 260 of the image is straight.

These two examples show how some matching functions can fail. For matching the hand pose, the middle skeleton 254 is a better fit to the original hand image 252. Based on the size of the non-overlapping regions, however, the right hand skeleton 256 is a better fit. The non-overlapping region for the skeleton on the right is smaller based on counting pixels or sample points. The total number of pixels around the edge of the hand is probably greater than the pixels of the end of the index finger. Similarly, by computing the Euclidean distance between points in the non-overlapping region to the closest point in the overlapping region, the right hand is again a better match. The sum of these Euclidean distances is smaller for the hand on the right since points on the index finger might find close points on the middle finger.

For these reasons, a different approach is taken for the non-overlapping regions. As described, the shortest path is taken from a point in the non-overlapping region to a point in the overlap region. Applying this function to FIG. 3, all the non-overlapping points in the middle hand would receive small values. The non-overlapping points on the edge of the image hand 252 are very close to overlapping points at the edge of the skeleton hand 254. Meanwhile, the non-overlapping points for the image hand 252 receive larger path distance values from the index finger to the palm. Summing the square of these values favors the middle skeleton 254 over the one on the right 256. Stated another way, instead of finding the closest point in Euclidean space, the summing function essentially computes the shortest Geodesic path from the outside point to the inside point in the overlap region and computes its projected distance.

Simply counting overlapping or non-overlapping points or looking for the inside point closest to each outside point will not always rank the skeletons correctly. As described herein semantically meaningful weights are assigned to the non-overlapping points and therefore the function generates a meaningful ranking between skeletons. An example sum is provided below in which a single weight w is used for both the overlap and the outside points.

f(skel,hand)=w·overlap+(1−w)·√(out_skel+out_hand) (Eq. 4)

The comparison function described in this disclosure performs a comparison between a 3D hand skeleton and a depth image of a hand in which the pixels that belong to the hand are marked as such.

The compare functions described herein use one or more batches of skeletons to evaluate against the hand image. Although the skeletons could be generated randomly, it may be more efficient to generate a first skeleton and then produce variations to iterate to a better result. The first skeleton may be based on an estimate of the hand image, a prior hand image, or any other basis. Because the subsequent skeletons are variations of the initial estimate, the subsequent skeletons will have some similar and may have some identical parts. As examples, the skeletons may have the same finger posture or palm orientation.

The relatedness of subsequent skeletons may be exploited to more easily construct a data structure which maps partial skeletons, such as fingers and palm orientations, and intermediate comparison values for a given hand depth image. When comparing a set of skeletons, before sampling a portion of the skeleton hand, the data structure may be checked to see if a similar part exists in it. If so, then the intermediate computations may be used instead of determining the values again. This strategy may be used to reduce the number of total computations required for comparing the entire set of skeletons.

Using the techniques described herein, occlusions can be ignored with little impact on the results. For a more controlled approach, occlusions may be detected and compensated. When rendering on a GPU a uniform sampling can be made of the skeleton being rendered from the camera's point of view. Such sampling will inherently account for occlusions and relative changes in distance. In order to simplify the comparisons described herein, the occlusion computations may be ignored. Instead, the sampling may be limited to the front side of the fingers and the palm. The front side will be the side that faces the depth camera. Since skeleton points are not explicitly used in the overlapping regions (Skelᵢₙ) and since skeleton points in the non-overlapping region (Skelₒᵤₜ), are used in image space rather than a 3D space, the occlusions can be ignored. The comparison will behave as if these regions were more densely sampled.

In the described technique the depth image of the hand is compared to skeleton points. However, it is also possible to compare the skeleton points to the depth image. This approach may be impacted by occlusions which have been ignored in the above description. When the 3D skeleton points are used explicitly during the computation, then occlusions are accounted for.

The occlusions may be accounted for using a scheme, such as the GPU's depth test. As an example, each projected point may be compared against a test depth image. If the projected point value is smaller than the value stored at the corresponding image pixel, i.e. the point is closer to the camera, then the point passes the test. The point's index is stored replacing the previous index for this pixel, and its depth value is written to the image. If the depth value is greater or equal to the value of the corresponding pixel in the image then the point is discarded. When using such a scheme with the 3D skeleton points, a set of occlusion free points can be defined and used explicitly in a 3D distance computation.

The described comparison approach may be applied to many different hand tracking systems that use a comparison between a skeleton and a hand image. The described comparison may be used with gradient descent, particle swarm and other optimization methods. The techniques described herein may be used as part of a hand-gesture-recognition system which may be part of a depth camera command interface system.

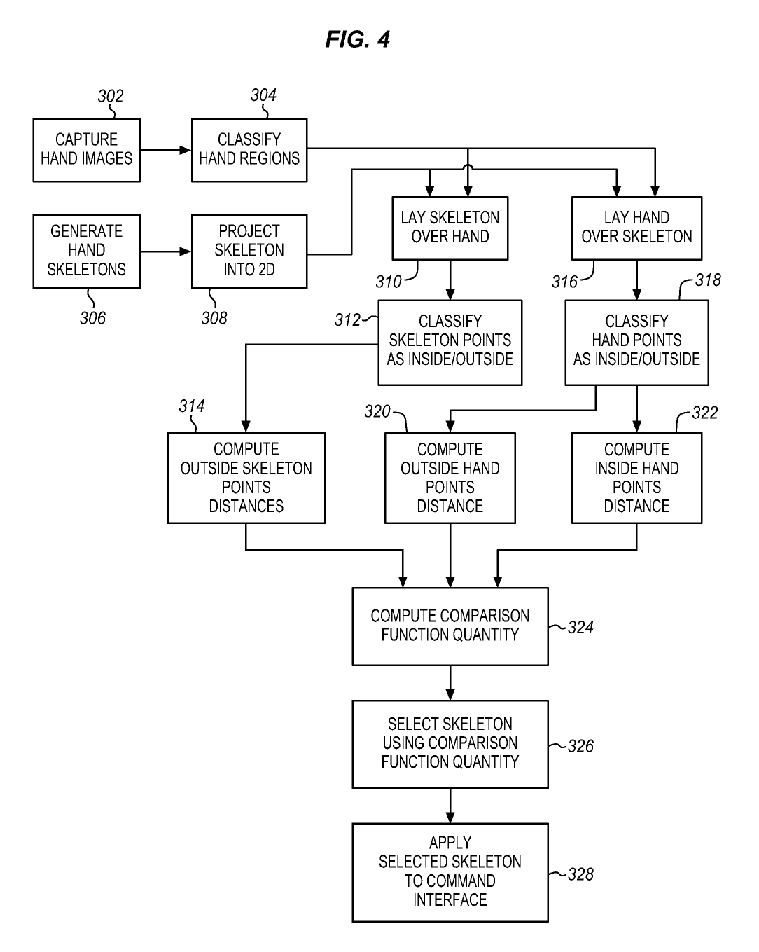

FIG. 4 is a process flow diagram showing some the operations described above, in the context of Equations 1-4. These operations may be performed in parallel as mentioned above as different threads or in different cores. At 302 hand image are captured by a camera system of a device. The camera system may be a depth camera system with two or more image sensors. At 304 regions of the captured hand in each frame are classified. In the examples herein the regions are classified as fingers and the palm. In addition or instead joints may also be identified and other parts of the hand and these features may then be associated with a region of each image that includes a hand.

At 308 points of the generated hand skeleton are projected onto a received hand image. This may be done by sampling points on a generated hand skeleton and projecting the sampled points onto the received hand image. At 312 the skeleton points are classified as being inside or outside the hand image. The inside and outside points are then treated in different ways. The comparison between the projected skeleton points and the hand image is quantified using a comparison function. The comparison quantity may be made up of several different components depending on the implementation. The components described herein are various distance measurements which are combined to provide a comparison value or quantity.

At 314 an outside skeleton distance is determined. This is a sum of distances from each outside skeleton point to a nearest inside skeleton point. In Eq. 2 the sum is a sum of the squares of these distances. By using squares, the values are weighted as compared to other values in the comparison function. For points which belong to a finger, the nearest inside skeleton point can be found by tracing a path of sampled points along the finger towards the skeleton's palm, stopping when the first inside point is reached. For points which belong to the palm, a search for the closest inside skeleton points can be done in linear time, by simply scanning all of the points, or in log time if a search structure is constructed. The resulting points are then projected onto the hand image and the sum of the distances between consecutive points along the path is computed. As shown in Eq. 2, these values may each be summed and then added together.

In addition at 316 the points of the received hand image are projected onto the points of the generated hand skeleton. The skeleton points are enlarged and then at 318 the sampled hand points are classified as being inside or outside of the enlarged skeleton points. For the comparison function distance measurement any of a number of different distance measures may be used. In this embodiment there are two distance measurements. The first at 320 is an outside hand distance. The second at 322 is an inside hand distance.

The outside hand distance includes a sum of distances, or even the sum of the square of the distances from each outside hand point to a nearest enlarged skeleton point. At 320, the distances of the outside hand distance are the geodesic distance between the outside hand points and the inside hand points. This can be approximated for example by using a distance transform. At 322 the inside hand distance includes a sum of the distance from each inside hand point to a nearest enlarged skeleton point.

At 324 the comparison function distance or quantity or value is determined for each combination of the captured input hand and a generated skeleton using the distances described above. These distances can include the outside skeleton point distances and the outside and inside hand distances. More or fewer or other distances may be used depending on the implementation. The comparison function distance measurement uses one or more weighting factors. The same factor may be used or different factors may be used for different distances. The process continues with projecting points of a second generated hand skeleton onto the received hand image and generating a comparison quantity so that there is a comparison function quantity for each skeleton. An additional distance measure may take self-intersections into account.

At 326 all of the comparison function quantities are used to select a generated hand skeleton that is the best match for the captured hand image and, at 328, the selected hand skeleton is used to generate a command to a computer system command interface.

System Architecture

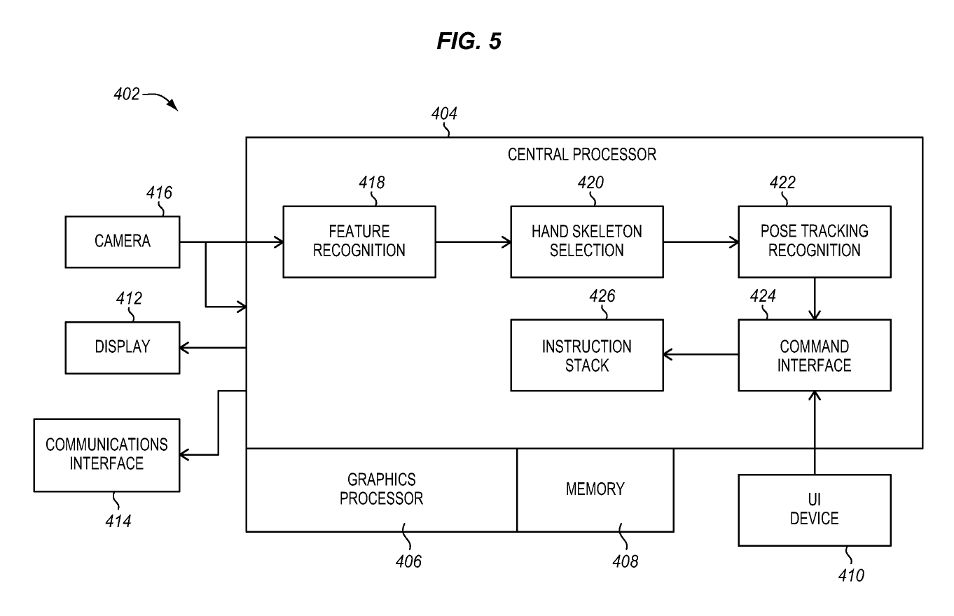

FIG. 5 is a block diagram of a system for implementing the gesture recognition described herein according to an embodiment. A system 402 may include a central processor 404, a graphics processor 406, and memory 408. These may be in the same or different integrated circuit dies, and the same or different packages. The central processor is coupled to one or more user interface devices 410, such as touch screens, buttons, and cursor control devices. The user interface devices are coupled to a command interface 424 that is coupled to an instruction stack 426. The instruction stack is a part of and supplies instructions for execution by the central processor, graphics processor, and memory. The memory 408 may store image data, hand model parameters, target positions, end-effector positions, finger labels, model selection parameters, convergence parameters, and any other data as discussed herein as well as commands and instructions for execution by the central processor.

The system is also coupled to a camera 416 such as a depth camera with multiple spaced apart image sensors, which supply input video frames to the processor 404 and to a feature recognition system 418. The camera may include internal processing an image signal processor or other components (not shown). The central processor 404 includes the feature recognition system 418 which provides recognized hand feature points to a hand skeleton selection system 420. The hand skeleton selection module generates hand skeletons and compares them to captured input hands and provides the selected skeleton to a hand pose tracking and recognition system. This system recognizes and interprets poses and movements of the recognized hand as authentication, commands, or other information and passes the recognized commands to the command interface 424.

As shown, in some examples, the feature recognition, hand skeleton selection, and hand tracking may be implemented by the central processor 404. In other examples, one or more or portions of these may be implemented by the graphics processor 406 or another processing unit.

The graphics processor 406 may be implemented via software or hardware or a combination thereof. Some of the functions described herein may be performed by an execution unit (EU) of the graphics processor.

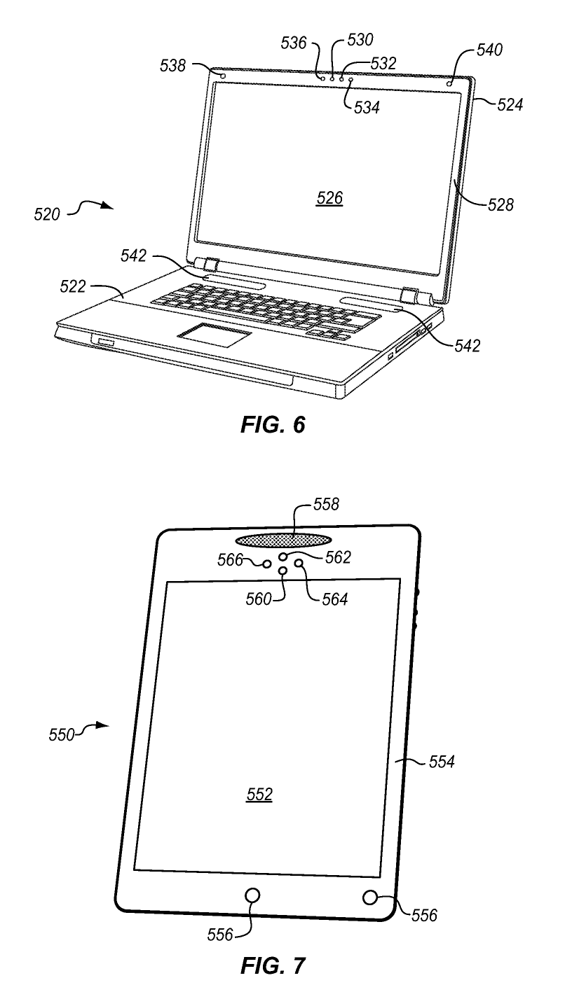

FIG. 6 is an isometric diagram of a portable device suitable for use with the depth camera hand skeleton selection system as described herein. This device is a notebook, convertible, or tablet computer 520 with attached keyboard. The device has a display section 524 with a display 526 and a bezel 528 surrounding the display. The display section is attached to a base 522 with a keyboard and speakers 542. The bezel is used as a location to mount two or three cameras 530, 532 for capturing depth enhanced video images of hands for authentication and gestures. The bezel may also be used to house a flash 534, a white flash or lamp 536 and one or more microphones 538, 540. In this example the microphones are separated apart to provide a spatial character to the received audio. More or fewer microphones may be used depending on the desired cost and audio performance. The ISP, graphics processor, CPU and other components are typically housed in the base 522 but may be housed in the display section, depending on the particular implementation.

This computer may be used as a conferencing or gaming device in which remote audio is played back through the speakers 542 and remote video is presented on the display 526. The computer receives local audio at the microphones 538, 540 and local video at the two composite cameras 530, 532. The white LED 536 may be used to illuminate the local user for the benefit of the remote viewer. The white LED may also be used as a flash for still imagery. The second LED 534 may be used to provide color balanced illumination or there may be an IR imaging system.

FIG. 7 shows a similar device as a portable tablet or smart phone. A similar approach may be used for a desktop monitor or a wall display. The tablet or monitor 550 includes a display 552 and a bezel 554. The bezel is used to house the various audiovisual components of the device. In this example, the bottom part of the bezel below the display houses two microphones 556 and the top of the bezel above the display houses a speaker 558. This is a suitable configuration for a smart phone and may also be adapted for use with other types of devices. The bezel also houses two cameras for depth 564, 566 stacked, and one or more LEDs 560, 562 for illumination. The various processors and other components discussed above may be housed behind the display and bezel or in another connected component.

The particular placement and number of the components shown may be adapted to suit different usage models. More and fewer microphones, speakers, and LEDs may be used to suit different implementations. Additional components, such as proximity sensors, rangefinders, additional cameras, and other components may also be added to the bezel or to other locations, depending on the particular implementation.

The video conferencing or gaming nodes of FIGS. 5 and 6 are provided as examples but different form factors such as a desktop workstation, a wall display, a conference room telephone, an all-in-one or convertible computer, and a set-top box form factor may be used, among others. The image sensors may be located in a separate housing from the display and may be disconnected from the display bezel, depending on the particular implementation. In some implementations, the display may not have a bezel. For such a display, the microphones, cameras, speakers, LEDs and other components may be mounted in other housing that may or may not be attached to the display.

In another embodiment, the cameras and microphones are mounted to a separate housing to provide a remote video device that receives both infrared and visible light images in a compact enclosure. Such a remote video device may be used for surveillance, monitoring, environmental studies and other applications, such as remotely controlling other devices such as television, lights, shades, ovens, thermostats, and other appliances. A communications interface may then transmit the captured infrared and visible light imagery to another location for recording and viewing.

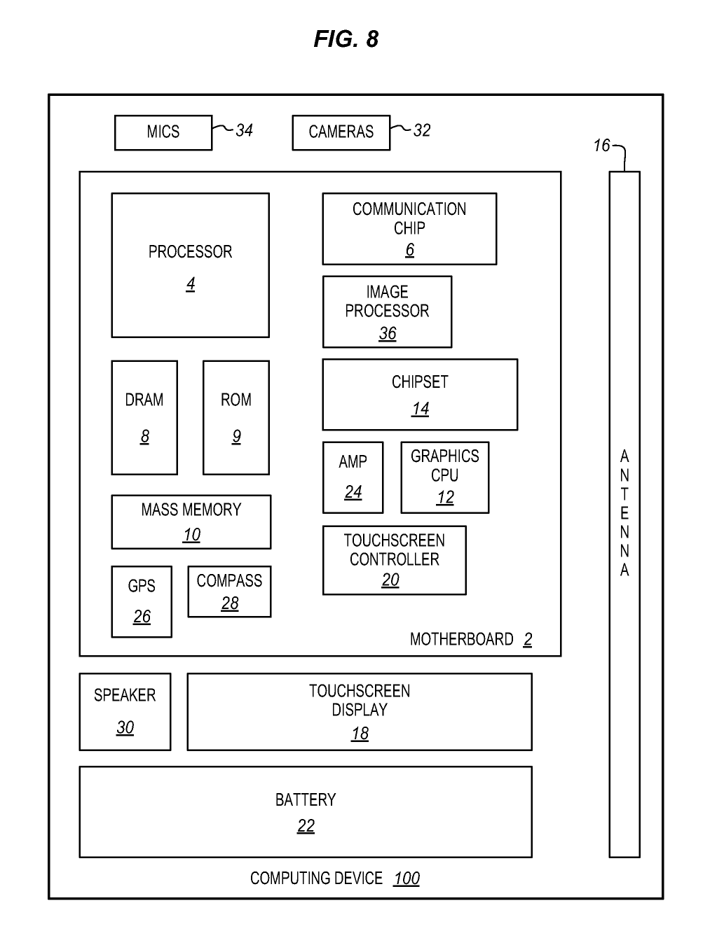

FIG. 8 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, cameras 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 including any depth sensors or proximity sensor are coupled to an optional image processor 36 to perform conversions, analysis, noise reduction, comparisons, depth or distance analysis, image understanding and other processes as described herein. The processor 4 is coupled to the image processor to drive the process with interrupts, set parameters, and control operations of image processor and the cameras. Image processing may instead be performed in the processor 4, the cameras 32 or in any other device.

In various implementations, the computing device 100 may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 100 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method that includes projecting points of a generated hand skeleton onto a received hand image, classifying the skeleton points as inside or outside the hand image, quantifying the comparison to generate a comparison quantity using a comparison function distance measurement, the comparison function distance measurement comprising an outside skeleton distance that includes a sum of distances from each outside skeleton point to a nearest inside skeleton point, applying the comparison function quantity to select the generated hand skeleton as a best match, and applying the selected hand skeleton to generate a command to a computer system command interface.

In further embodiments the sum of the outside skeleton distance comprises a sum of the squares of the distances from each outside skeleton point to a nearest inside skeleton point.

In further embodiments the nearest inside skeleton point of the outside skeleton distance is found for points which belong to a finger by tracing a path of sampled points along the finger.

In further embodiments the nearest inside skeleton point of the outside skeleton distance is found for points which belong to a palm by searching for a closest inside skeleton point by scanning all inside skeleton points.

In further embodiments the outside skeleton distance is determined by projecting a path from each outside skeleton point to the nearest inside skeleton point onto the received hand image and taking the distance on the hand image.

Further embodiments include generating a set of hand image samples, enlarging the skeleton points, and classifying the sampled hand points as inside or outside the enlarged skeleton points, wherein the comparison function distance measurement further comprises an outside hand distance that includes a sum of distances from each outside hand point to a nearest enlarged skeleton point.

In further embodiments the distances of the outside hand distance are a geodesic distance from an inside hand point to a nearest inside hand point.

In further embodiments the sum of the distances from each outside hand point comprises the square of each distance taken before summing.

In further embodiments the distances of the outside hand distance are distances to a nearest hand region determined using a geodesic distance.

In further embodiments projecting points of a generated hand skeleton comprises sampling points on a generated hand skeleton and projecting the sampled points onto a received hand image.

In further embodiments the comparison function distance measurement further comprises an inside skeleton distance that includes a sum of the distance from each inside skeleton point to the hand image.

In further embodiments the comparison function distance measurement comprises a weighting factor for the outside skeleton distance and a weighting factor for the inside skeleton distance.

In further embodiments the comparison function distance measurement further comprises an inside hand distance that includes a sum of the distance from each inside hand point to a nearest enlarged skeleton point.

In further embodiments the comparison function distance measurement comprises a weighting factor for the outside skeleton distance, for the outside hand distance, and for the inside hand distance.

Further embodiments include

projecting points of a second generated hand skeleton onto the received hand image and generating a comparison quantity and selecting the generated hand skeleton comprises comparing the comparison quantity for the first generated hand skeleton to the comparison quantity for the second generated hand skeleton.

Some embodiments pertain to a non-transitory computer-readable medium having instructions thereon that when operated on by the computer causes the computer to perform operations that include projecting points of a generated hand skeleton onto a received hand image, classifying the skeleton points as inside or outside the hand image, quantifying the comparison to generate a comparison quantity using a comparison function distance measurement, the comparison function distance measurement comprising an outside skeleton distance that includes a sum of distances from each outside skeleton point to a nearest inside skeleton point, applying the comparison function quantity to select the generated hand skeleton as a best match, and applying the selected hand skeleton to generate a command to a computer system command interface.

Further embodiments include generating a set of hand image samples, enlarging the skeleton points, and classifying the sampled hand points as inside or outside the enlarged skeleton points, wherein the comparison function distance measurement further comprises an outside hand distance that includes a sum of distances from each outside hand point to a nearest enlarged skeleton point.

Some embodiments pertain to a computing system that includes a camera to generate an input sequence of frames, a feature recognition system to identify frames of the sequence in which a hand is recognized and to identify points in the identified frames corresponding to features of the recognized hand, a hand skeleton selection system to project points of a generated hand skeleton onto a received hand image, to classify the skeleton points as inside or outside the hand image, to quantify the comparison to generate a comparison quantity using a comparison function distance measurement, the comparison function distance measurement comprising an outside skeleton distance that includes a sum of distances from each outside skeleton point to a nearest inside skeleton point, to apply the comparison function quantity to select the generated hand skeleton as a best match, and to apply the selected hand skeleton to generate a command to a computer system command interface, and a command interface to receive commands from the hand skeleton selection system for operation by a processor of the computing system.

In further embodiments the sum of the outside skeleton distance comprises a sum of the squares of the distances from each outside skeleton point to a nearest inside skeleton point.

In further embodiments the nearest inside skeleton point of the outside skeleton distance is found for points which belong to a finger by tracing a path of sampled points along the finger.

What is claimed is:

1. A method comprising:
projecting points of a generated hand skeleton onto a received hand image;
classifying the skeleton points as inside or outside the hand image;
quantifying the comparison to generate a comparison quantity using a comparison function distance measurement, the comparison function distance measurement comprising an outside skeleton distance that includes a sum of distances from each outside skeleton point to a nearest inside skeleton point;
applying the comparison function quantity to select the generated hand skeleton as a best match; and
applying the selected hand skeleton to generate a command to a computer system command interface.

2. The method of claim 1, wherein the sum of the outside skeleton distance comprises a sum of the squares of the distances from each outside skeleton point to a nearest inside skeleton point.

3. The method of claim 1, wherein the nearest inside skeleton point of the outside skeleton distance is found for points which belong to a finger by tracing a path of sampled points along the finger.

4. The method of claim 1, wherein the nearest inside skeleton point of the outside skeleton distance is found for points which belong to a palm by searching for a closest inside skeleton point by scanning all inside skeleton points.

5. The method of claim 1, wherein the outside skeleton distance is determined by projecting a path from each outside skeleton point to the nearest inside skeleton point onto the received hand image and taking the distance on the hand image.

6. The method of claim 1, further comprising;
generating a set of hand image samples;
enlarging the skeleton points; and
classifying the sampled hand points as inside or outside the enlarged skeleton points,
wherein the comparison function distance measurement further comprises an outside hand distance that includes a sum of distances from each outside hand point to a nearest enlarged skeleton point.

7. The method of claim 6, wherein the distances of the outside hand distance are a geodesic distance from an outside hand point to a nearest inside hand point.

8. The method of claim 7, wherein the sum of the distances from each outside hand point comprises the square of each distance taken before summing.

9. The method of claim 6 wherein the distances of the outside hand distance are distances to a nearest hand region determined using a geodesic distance.

10. The method of claim 1, wherein projecting points of a generated hand skeleton comprises sampling points on a generated hand skeleton and projecting the sampled points onto a received hand image.

11. The method of claim 1, wherein the comparison function distance measurement further comprises an inside skeleton distance that includes a sum of the distance from each inside skeleton point to the hand image.

12. The method of claim 11, wherein the comparison function distance measurement comprises a weighting factor for the outside skeleton distance and a weighting factor for the inside skeleton distance.

13. The method of claim 6, wherein the comparison function distance measurement further comprises an inside hand distance that includes a sum of the distance from each inside hand point to a nearest enlarged skeleton point.

14. The method of claim 13, wherein the comparison function distance measurement comprises a weighting factor for the outside skeleton distance, for the outside hand distance, and for the inside hand distance.

15. The method of claim 1 further comprising projecting points of a second generated hand skeleton onto the received hand image and generating a comparison quantity and selecting the generated hand skeleton comprises comparing the comparison quantity for the first generated hand skeleton to the comparison quantity for the second generated hand skeleton.

16. A non-transitory computer-readable medium having instructions thereon that when operated on by the computer causes the computer to perform operations comprising:
projecting points of a generated hand skeleton onto a received hand image;
classifying the skeleton points as inside or outside the hand image;
quantifying the comparison to generate a comparison quantity using a comparison function distance measurement, the comparison function distance measurement comprising an outside skeleton distance that includes a sum of distances from each outside skeleton point to a nearest inside skeleton point;
applying the comparison function quantity to select the generated hand skeleton as a best match; and
applying the selected hand skeleton to generate a command to a computer system command interface.

17. The medium of claim 16, the operations further comprising:
generating a set of hand image samples;
enlarging the skeleton points; and
classifying the sampled hand points as inside or outside the enlarged skeleton points,
wherein the comparison function distance measurement further comprises an outside hand distance that includes a sum of distances from each outside hand point to a nearest enlarged skeleton point.

18. A computing system comprising:
a camera to generate an input sequence of frames;
a feature recognition system to identify frames of the sequence in which a hand is recognized and to identify points in the identified frames corresponding to features of the recognized hand;
a hand skeleton selection system to project points of a generated hand skeleton onto a received hand image, to classify the skeleton points as inside or outside the hand image, to quantify the comparison to generate a comparison quantity using a comparison function distance measurement, the comparison function distance measurement comprising an outside skeleton distance that includes a sum of distances from each outside skeleton point to a nearest inside skeleton point, to apply the comparison function quantity to select the generated hand skeleton as a best match, and to apply the selected hand skeleton to generate a command to a computer system command interface; and
a command interface to receive commands from the hand skeleton selection system for operation by a processor of the computing system.

19. The system of claim 18, wherein the sum of the outside skeleton distance comprises a sum of the squares of the distances from each outside skeleton point to a nearest inside skeleton point.

20. The method of claim 18, wherein the nearest inside skeleton point of the outside skeleton distance is found for points which belong to a finger by tracing a path of sampled points along the finger.
